(19) United States
(12) Patent Application Publication
(10) Pub. No.: US 2007/0230664 A1
(43) Pub. Date: Oct. 4, 2007

(54) Collimator for x-ray spectrometry, and an x-ray spectrometric apparatus

(75) Inventors: Heikki Sipila, Espoo (FI); Seppo Nenonen, Espoo (FI)

Correspondence Address: WOOD, PHILLIPS, KATZ, CLARK & MORTIMER, 500 W. MADISON STREET, SUITE 3800, CHICAGO, IL, 60661, US

(73) Assignee: Oxford Instruments Analytical Oy

(21) Appl. No.: 11/397,284

(22) Filed: Apr. 4, 2006

(51) Int. Cl. G21K 1/02

(52) U.S. Cl. 378/149

(57) ABSTRACT

A collimator for collimating X-rays in an X-ray spectrometric measuring apparatus comprises a body of a microchannel plate (203, 205, 701, 702, 703, 704, 705, 711, 712, 713, 714, 715, 801, 901, 1003). Most advantageously the channel walls of the microchannel plate are plated with a thin coating (310) of a heavy metal.

### TECHNICAL FIELD

The invention concerns generally the technical field of components used on the path of the X-ray radiation that travels between a radiation source, a target, and a detector in a spectrometric analyser device. Especially the invention concerns collimators that only allow radiation to pass in a certain propagating direction.

FIG. 1 illustrates schematically an X-ray crystal spectrometer for X-ray fluorescence measurements. A radiation source 101 emits X-rays towards a target 102 causing it to emit fluorescent X-rays. The spectral content, i.e. intensity at different wavelengths, of the fluorescent radiation is of interest and should be measured. For this purpose a first collimator 103 selects a part of the fluorescent radiation that proceeds into a particular direction. The selected fluorescent radiation hits a crystal 104, which acts as a wavelength-dispersive reflector according to Bragg's reflection law nλ=2d sin(θ), where n is the order of reflection, λ is the wavelength of the reflected radiation, d is the lattice constant of the crystal and θ is the reflection angle. A second collimator 105 conveys the reflected radiation to a detector 106.

The most conventional collimator structure consists of a stack of tightly spaced, parallel metal plates or foils. This structure has been used in crystal spectrometers meant for laboratory use, and it has its advantages: it is relatively cheap and mechanically robust, and the angular selectivity can easily be made almost arbitrarily high by making the metal plates long enough in the propagating direction of the radiation. However, large size is a major drawback in some applications, especially in portable analyser devices. Another problem is the difficulty of aligning all metal plates properly, especially if they are very thin foils. A need thus exists for more compact collimator solutions that would be smaller and lighter.

A patent U.S. Pat. No. 6,477,226 discloses the use of an anisotropically etched semiconductor plate as a collimator. The idea is that since etching can be highly anisotropic with known techniques, it can be utilized to “drill” an array of deep holes through the semiconductor. An important structural parameter of a collimator of that kind is the aspect ratio, defined as the thickness of the plate divided by the hole diameter. The aspect ratio should be in the order of 50-100. Since the hole diameter is in the order of micrometers, a semiconductor plate does not need to be more than one millimeter thick for acting as a collimator. This is a remarkable improvement over the required length of several centimeters of the collimators that consist of a stack of metal plates. However, the perforated semiconductor plate is very brittle, which problem becomes worse if one tries to decrease unwanted attenuation by making the walls between adjacent holes thinner.

From a publication O. V. Makarova, G. Yang, C-M Tang, D. C. Mancini, R. Divan, J. Yaeger: “Fabrication of Collimators for Gamma-ray Imaging”, Proceedings of SPIE Design and Microfabrication of Novel X-Ray Optics II, 5-6 Aug. 2004, Denver, Colo., Volume 5539, pp. 126-132 (2004) there is known a gamma-ray collimator that consists of a stack of perforated layers. Each layer is manufactured by applying deep X-ray lithography and gold electroforming. The drawback of this solution is the complicatedness of manufacture as well as the still relatively large overall thickness (more than 15 mm) of the completed collimator.

### SUMMARY OF THE INVENTION

It is an objective of the present invention to provide an X-ray collimator structure that is thin and easy to manufacture and that has good transmittance in the range of allowable input angles. An additional objective of the invention is to provide an X-ray spectrographic analyser device that is compact and has low manufacturing costs.

The objectives of the invention are achieved by using a microchannel plate as the basic structure of the collimator. Transmission efficiency is greatly enhanced by plating the walls of the channels in the microchannel plate with a thin layer of a material that reflects X-rays well at shallow incident angles.

According to a first aspect of the invention, the invention applies to a collimator for collimating X-rays in an X-ray spectrometric measuring apparatus. The collimator comprises a body of a microchannel plate.

According to a second aspect of the invention, the invention applies to a collimator for collimating X-rays in an X-ray spectrometric measuring apparatus. The collimator comprises a planar body, which is made of glass and defines a periodic array of channels through the body, the diameter of each channel being between 5 and 15 micrometers.

According to a third aspect of the invention, the invention applies to the use of a microchannel plate for collimating X-rays in an X-ray spectrometric measuring apparatus.

According to a fourth aspect of the invention, the invention also applies to a spectrometric apparatus that comprises a mechanically supporting body part and a collimator attached to said body part and arranged to collimate X-rays incident upon the collimator. The collimator comprises a body of a microchannel plate.

A microchannel plate is a device that has conventionally been used as an image intensifier, i.e. an analog amplifying component in detecting charged particles or electromagnetic radiation. It consists of a glass plate with a periodic array of microscopic holes therethrough. The thickness of the glass plate is usually slightly less or slightly more than one millimeter, and a typical diameter of the holes is in the order of about ten micrometers. Thus each hole constitutes a channel through the glass plate, with an aspect ratio of typically about 100, although large deviations from these exemplary values are possible. For use as an image intensifier, the walls of the channels have been treated so that they enable the easy emission of photoelectrons and an avalanche-like multiplication of emitted electrons under the influence of an electric field between electrode metallizations on the top and bottom surfaces of the plate.

According to an aspect of the present invention, it is possible to use a previously known microchannel plate as such as an X-ray collimator. However, the transmission efficiency at acceptable incoming angles becomes much better, if the channel walls of a microchannel plate are treated to act like mirrors, so that they reflect incoming X-rays instead of causing photoelectric emission. Thus each channel in the microchannel plate acts as a miniature waveguide that exhibits high transmissivity at a relatively narrow range of acceptable input angles around the nominal channel direction. A suitable treatment is the plating of the channel walls with a layer of a metal such as iridium, ruthenium or nickel, having a thickness of a few nanometers. An exemplary method for applying such a treatment is ALD (Atomic Layer Deposition).

A spectrometric apparatus according to the invention comprises at least one collimator that has the characteristics described above. Most advantageously the spectrometric apparatus comprises a precision-machined body part, which can be produced with such a high accuracy and reproducibility that certain tuning that used to be a part of the assembling process can be omitted. The body part may also provide directly some functionalities that are needed on the optical path; e.g. a surface in a metallic body part may be polished to act as a mirror.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

FIG. 1 illustrates a prior art X-ray crystal spectrometer,

FIG. 2 illustrates an X-ray crystal spectrometer according to an embodiment of the invention,

FIG. 3 illustrates the plating of the channel walls of a microchannel plate,

FIG. 4 illustrates the concept of an acceptable incoming angle,

FIG. 5 illustrates the concept of the width of an acceptance function,

FIG. 6 illustrates certain method steps of producing a microchannel plate collimator,

FIG. 7 illustrates a microchannel plate arrangement that has collimating and focusing functionality,

FIG. 8 illustrates a microchannel plate collimator with varying bias angle of channels,

FIG. 9 illustrates an alternative to the collimator of FIG. 8, with a curved microchannel plate, and

FIG. 10 illustrates a part of an X-ray crystal spectrometer according to an embodiment of the invention.

### DETAILED DESCRIPTION OF THE INVENTION

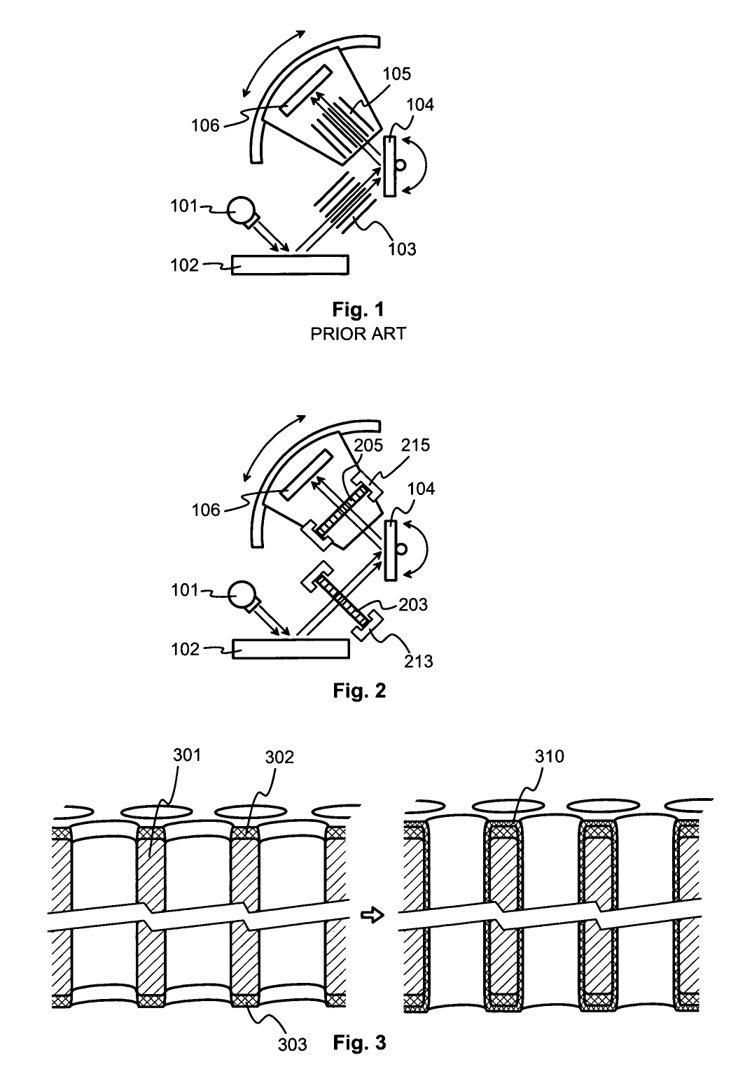

FIG. 2 illustrates schematically an X-ray crystal spectrometer, in which the X-ray source 101, the target 102, the crystal 104 and the detector 106 are similar to corresponding elements in the prior art device of FIG. 1. Instead of the prior art collimators, the X-ray crystal spectrometer of FIG. 2 comprises a first microchannel plate 203 and a second microchannel plate 205, held in place by a first holder 213 and a second holder 215 respectively. In FIG. 2 we assume that the first and second microchannel plates 203 and 205 are of the zero bias angle type, where the channel direction is perpendicular to the plate surface, which means that in order to act as collimators, the first and second microchannel plates 203 and 205 must be transversally located with respect to the path of the X-ray radiation.

FIG. 3 illustrates the principle of plating the channels of a microchannel plate so that it becomes a better collimator for X-rays. On the left is a schematic cross section of a small portion of an ordinary microchannel plate, of which a large part of the middle section has been omitted in order to add graphical clarity. In reality the channel length would be dozens of times larger than the channel width. The body 301 of the microchannel plate consists of lead oxide glass or other material that is suitable for the manufacturing process. An ordinary microchannel plate also comprises a top electrode layer 302 and a bottom electrode layer 303 usually made of chromium and/or nickel alloys.

On the right in FIG. 3 is a schematic cross section of a small portion of a microchannel plate for use as an effective X-ray collimator. A very thin conformal coating 310 has been added. The thickness of the coating 310 is preferably in the order of nanometers, like 5 nanometers. In the drawing it has been vastly exaggerated: taken that the channel width is in the order of several micrometers, drawn to scale the coating 310 would be hardly visible in the drawing.

Whether or not the coating 310 also covers the top and bottom surfaces of the microchannel plate is immaterial to the present invention. It is much more important that the coating 310 covers the walls of the channels and has as smooth a surface as possible. The smoothness requirement is one reason for not making the coating 310 thicker than a few nanometers, since the thicker the layer, the more easily its surface becomes uneven. Another reason for the small thickness of the coating 310 on the walls of the channels is that unnecessarily decreasing the channel cross-section will just reduce the transmission ratio of X-rays.

A number of important criteria are set to the material used for the coating 310. The material should have a high atomic ordinal number in order to reflect X-rays as effectively as possible. The material should be well suited for application as very thin conformal layers, using atomic layer deposition (ALD) or other suitable coating method. Additionally it is advantageous if the material of the coating 310 does not have characteristic X-ray fluorescence peaks that could be easily confused with those of analysed materials in the target. The most suitable material for the coating 310 is believed to be iridium. Other suitable materials include but are not limited to ruthenium and nickel, of which at least the latter is more suitable for application through wet chemistry than ALD. Platinum and gold are known to be applicable as X-ray mirror materials, but they may have other disadvantages that make them a suboptimal choice for the material of the coating 310.

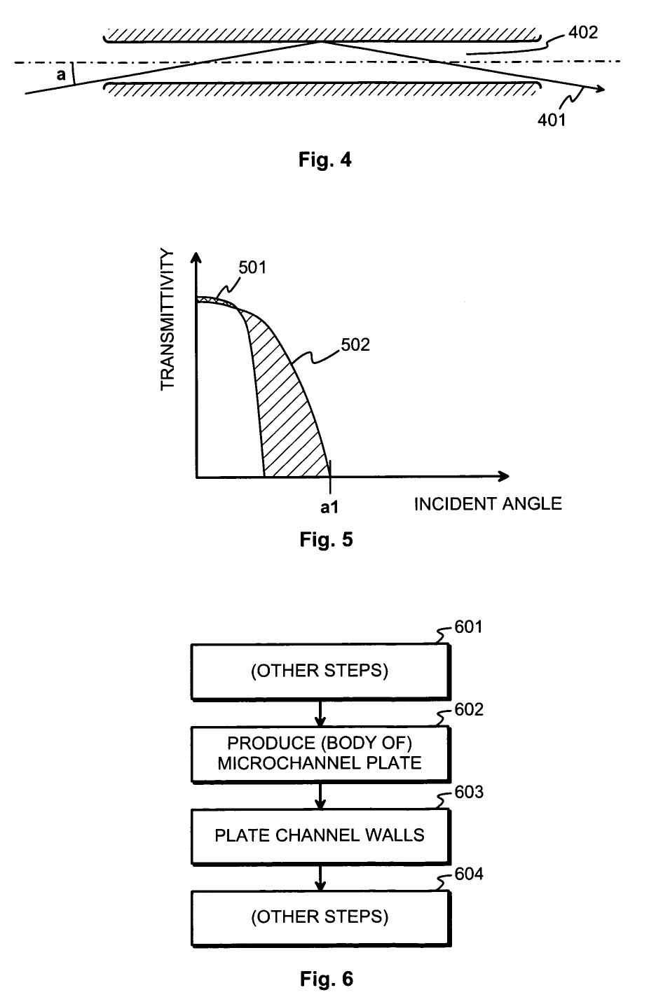

FIG. 4 illustrates an X-ray 401 that enters a channel 402 in a microchannel plate at an incident angle a that is greater than zero (here incident angle is defined as the angle between the axial direction of the channel and the propagation direction of the X-ray). If the incident angle was zero, the X-ray 401 would pass straight through the channel, assuming that it did enter the channel in the first place and did not hit some of the solid parts of the front surface of the microchannel plate, in which case it would become absorbed. Let us first assume that the channel walls have not been plated. In that case there is some relatively small limiting value for the angle a, so that at incident angles larger than the limiting value the X-ray could not pass directly through the channel but would hit the wall instead. An unplated glass wall is not a very good reflector for X-rays, but would be very likely to cause absorption. Depicting transmittivity as a function of incident angle would give something like the qualitative curve 501 in FIG. 5.

Let us now assume that the channel walls have been plated in accordance with an aspect of the present invention. The plating allows the obliquely entering X-rays to reflect once or several times on their way through the channel, which in terms of transmittivity as a function of incident angle gives the qualitative curve 502 of FIG. 5. At a zero incident angle the transmittivity curve 502 is slightly lower than the curve 501, because the plating causes a small decrease in channel diameter and correspondingly increases the possibility of a directly coming X-ray to miss the channel and hit the front surface of the microchannel plate instead. However, taken that the thickness of the plating is easily less than one thousandth of the channel diameter, this decrease in zero-angle transmittivity is almost infinitesimally small, and only exaggerated in FIG. 5 for clarity. On the other hand, due to the highly increased reflectivity of the channel walls, transmittivity experiences a large increase at larger values of the incident angle. The overall transmittivity of a collimator is proportional to an integral of the area that is left under the transmittivity curve in FIG. 5. The increased overall transmittivity due to better transmittivity at larger incident angles is shown with a simple hatch, while the small decrease in small-incident-angle transmittivity is shown with a cross hatch.

The applicability of a microchannel plate with plated channel walls as a collimator comes from the fact that a collimator can well have a certain allowance function of finite width around the nominal propagating direction that should pass directly through the collimator, as long as the maximum deviation al from the zero incident angle, at which radiation will still pass, is not so large that it would cause serious degradation in the energy (wavelength) resolution of the crystal spectrometer. How wide the allowance function can be, i.e. how much a propagating direction is allowed to differ from the nominal propagating direction and still be accepted to pass the collimator, depends on the application for which the collimator is used. According to the invention, it is easy to design and manufacture collimators with differently dimensioned allowance functions by simply selecting the aspect ratio of the microchannel plate, i.e. by selecting a suitable plate thickness (typically between 0.4 and 3 millimeters) and channel width (typically between 5 and 15 micrometers). Also the material selected for the plating of the channel walls, and the resulting degree of reflectivity of the channel walls, is a parameter to be considered when the maximum allowable value of al is decided. It is expected that the increase in the allowance function width will in any cases be less than two degrees compared to the allowance function of a correspondingly dimensioned microchannel plate with unplated channels.

X-ray reflection at grazing incidence is known to be non-dispersive. This means that the collimator according to the invention does not add any significant dependency on wavelength to the optical transfer function of an X-ray crystal spectrometer.

FIG. 6 illustrates schematically certain method steps that aim at manufacturing an X-ray collimator according to an embodiment of the invention. The process may contain some previous steps of unspecified nature, illustrated as 601. In step 602 at least the body of a microchannel plate is produced. In a typical manufacturing process of microchannel plates, a rod of etchable core glass is used as a support for a hollow billet of lead oxide cladding glass. A composite fibre is pulled from the combination. A number of these first draw fibres are stacked into an array, which is drawn again to produce a so-called multifiber. Several multifibres are stacked and fused together under vacuum, which results in a thick rod-like product known as a boule. The boule is sliced and polished to the required thickness and outline of the desired microchannel plates. The solid cores, which at this stage still perforate the plate, are etched away, thus producing the characteristic array of microscopic holes through the plate.

A complete manufacturing process of microchannel plates involves firing the plates in a hydrogen oven to produce a semiconducting surface layer with the desired resistance and secondary electron yield, as well as producing the top and bottom electrode layers. For the purposes of the present invention these are unnecessary steps and can be left out. However, they do not cause much change either to the operation of the microchannel plate as an X-ray collimator, so concerning the present invention it is immaterial, whether step 602 of the manufacturing process includes the hydrogen firing and electrode producing substeps or not.

Step 603 involves plating the channel walls with the thin coating reflective of X-rays, for example in an ALD process. Other method steps may follow after that as is illustrated as 604.

A microchannel plate meant for use as a particle detector or image intensifier has often a so-called nonzero bias angle, which means that the channels are not perpendicular to the planar surfaces of the plate. The bias angle is selected in step 602 mentioned above, by tilting the blade that is used to cut slices from the boule (or by tilting the boule with respect to the blade). If a microchannel plate with plated channel walls is to be used as a collimator according to an embodiment of the invention, it should either have a zero bias angle, or the microchannel plate should be placed at a non-perpendicular angle with respect to the desired propagation direction of X-rays, so that the channel direction coincides with the desired propagation direction of X-rays.

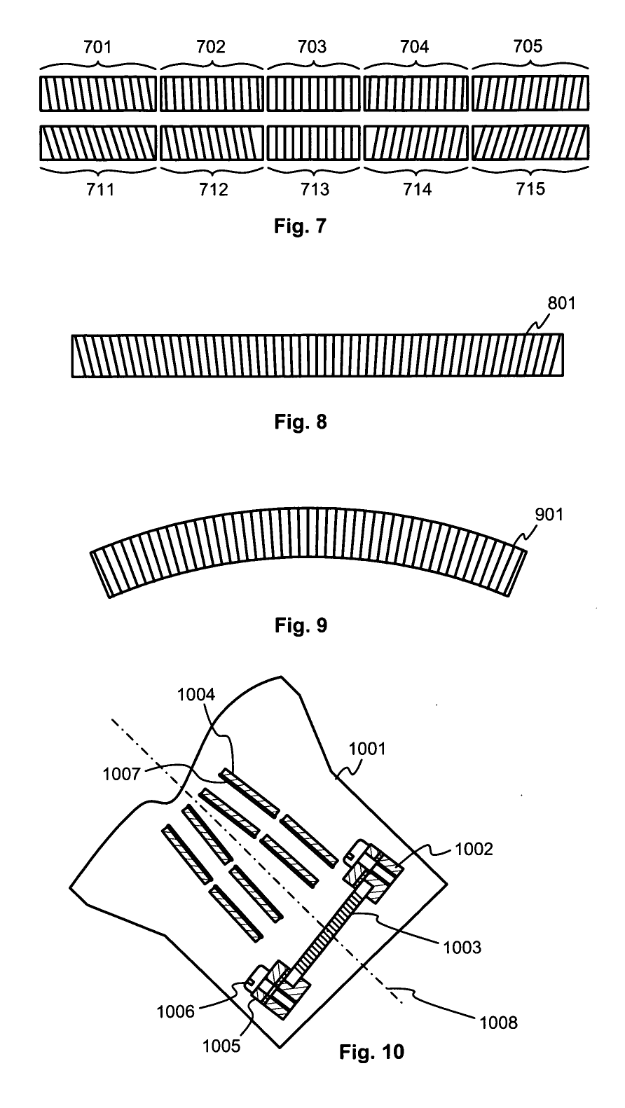

FIG. 7 is a cross section that shows how an assembly of differently cut microchannel plates can be used as a combined collimator and focusing lens for X-rays. We assume that radiation comes from top to down. The upper row of microchannel plates has a central plate 703 with zero bias angle. On each side of it there are plates 702 and 704, with small bias angles of equal absolute magnitude but opposite sign. The utmost plates 701 and 705 constitute a similar pair, having bias angles of equal absolute magnitude but opposite sign, said magnitude being slightly larger than that of plates 702 and 704. In the lower row the same principal arrangement is repeated, with the central plate 713 having zero bias angle, the intermediate plates 712 and 714 constituting an equal-magnitude and opposite-sign pair and the utmost plates 711 and 715 likewise. The increasing steps in the absolute value of the bias angle are larger in the lower row, with plates 711 and 715 having the largest absolute bias angle magnitude in the whole assembly. X-rays will only reflect at very shallow

X-rays that pass through the microchannel plate assembly of FIG. 7 from top to down will experience certain convergence that directs them at least approximately towards a focal point located further down. Similar lens-like effects are achieved if the manufacturing process of the microchannel plate allows the bias angle to be gradually changed across the plate like in the plate 801 of FIG. 8, or if a microchannel plate with initially parallel channels is afterwards made to exhibit some curvature like plate 901 in FIG. 9. Microchannel plates and microchannel plate arrangements that include a focusing characteristic, like the ones shown in FIGS. 7, 8, and 9, can be said to be special cases of the concept “collimator”, because they still act as pure collimators at least for those X-rays that pass through the central region (or more generally: the region where the channel direction is the same as the incident direction of those X-rays that should pass), and because they only allow X-rays with incident propagating directions within the (relatively narrow) allowance function to pass. Thus also the embodiments shown in FIGS. 7, 8, and 9 fall within the scope of the claims directed to a collimator. It should be noted that for reasons of graphical clarity, the differences in bias angle and the curvature of the microchannel plate in FIG. 9 have been exaggerated.

FIG. 10 illustrates schematically how it is possible to utilize the manufacturing accuracy of a precision machined body part in an X-ray crystal spectrometer according to an embodiment of the invention. We assume that the X-ray crystal spectrometer comprises a body part 1001 made of e.g. aluminium, which is easily applicable to precision machining in a numerically controlled milling machine. At one part the body part 1001 comprises an integrated holder 1002 for a microchannel plate collimator 1003 according to an embodiment of the invention. At another part the body part 1001 comprises a mirror arrangement, which here is shown to consist of eight suitably directed mirror segments such as segment 1004. The accuracy of numerically controlled machining implies that the final structure can be assembled (using additional parts if necessary, for example flanges 1005 and screws 1006) with little or no additional need for tuning positions, angles and other characteristics of the assembled parts. The precision machined surfaces of some parts of the body part 1001 also constitute a good basis for further processing, such as the application of a thin heavy metal reflective plating 1007 of the mirror surfaces.

Naturally, if the X-ray spectrometric measuring apparatus is a crystal spectrometer in which the measurement requires detecting X-rays propagating in various directions, an angular moving mechanism is needed. Such a mechanism should not be confused with the missing position tuning means and location angle tuning means, which are not needed in attaching the collimator to its place because of the accuracy of producing the body part.

FIG. 10 also illustrates the practice of using a microchannel plate the bias angle of which is constant but not zero (here 7 degrees). The microchannel plate collimator 1003 is just placed at an angle in which its channels are parallel to the desired propagation direction 1008 of X-rays, which means that the planar direction of the microchannel plate is not exactly perpendicular to the desired propagation direction of X-rays.

The use of a microchannel plate with plated channel walls as a collimator in an X-ray spectrometric measuring apparatus has also further implications than just the possibility of making the apparatus smaller due to the miniature thickness of the collimator. As we pointed out above in association with FIG. 5, the plating increases the transmittivity at incident angles that are not exactly parallel to the nominal propagation direction but still well within acceptable range. An X-ray spectrometric measurement is typically characterized by a scarcity of sufficient intensity of radiation at desired wavelengths, which must be compensated for by increasing measurement times and/or using more intense incident radiation. If the apparatus has a collimator according to an embodiment of the present invention, a larger portion of the desired radiation may be collected, which means that the overall measurement time may be shortened and/or the X-ray tube or other radiation source can be driven with lower input currents. The last-mentioned has further advantageous effects in decreasing potential of radiation hazards, less need for cooling, lighter and smaller structures and the like.

Many variations to the exemplary embodiments described above are possible. For example, even if the exemplary X-ray crystal spectrometers described above have had exactly one microchannel plate collimator between the sample and the crystal and exactly one between the crystal and the detector, other numbers are possible. It is not necessary to make all collimators of an X-ray crystal spectrometer of microchannel plates.

We claim:

1. A collimator for collimating X-rays in an X-ray spectrometric measuring apparatus, the collimator comprising a body of a microchannel plate.

2. A collimator according to claim 1, wherein walls of channels through said body comprise a coating made of metal.

3. A collimator according to claim 2, wherein said coating is made of iridium.

4. A collimator according to claim 2, wherein said coating is made of a material taken from the group consisting of ruthenium and nickel.

5. A collimator according to claim 2, wherein said coating has a thickness of essentially 5 nanometers.

6. A collimator according to claim 1, wherein said body is made of lead oxide glass and has a thickness between 0.4 and 3 millimeters.

7. A collimator according to claim 6, wherein channels through said body have a diameter between 5 and 15 micrometers.

8. A collimator according to claim 1, comprising a multitude of microchannel plate portions with different bias angles, so that microchannel plate portions located at a distance from a central axis of the collimator have bias angles adapted to divert X-rays towards said central axis.

9. A collimator for collimating X-rays in an X-ray spectrometric measuring apparatus, the collimator comprising a planar body, which is made of glass and defines a periodic array of channels through the body, the diameter of each channel being between 5 and 15 micrometers.

10. The use of a microchannel plate for collimating X-rays in an X-ray spectrometric measuring apparatus.

11. An X-ray spectrometric apparatus, comprising:
a mechanically supporting body part, and
a collimator attached to said body part and arranged to collimate X-rays incident upon the collimator;
wherein the collimator comprises a body of a microchannel plate.

12. An X-ray spectrometric apparatus according to claim 11, comprising:
a holder formed integrally with said body part,
an attachment of said body of a microchannel plate to said holder without position tuning means and without location angle tuning means, and
a mechanism for moving said holder to different angular locations with respect to X-rays propagating within the X-ray spectrometric apparatus.

13. An X-ray spectrometric apparatus according to claim 11, comprising a multitude of microchannel plate portions with different bias angles, so that microchannel plate portions located at a distance from a central axis of the collimator have bias angles adapted to divert X-rays towards said central axis.

14. An X-ray spectrometric apparatus according to claim 11, wherein channels through said body of a microchannel plate are not perpendicular to the planar surfaces of said body of a microchannel plate, and said collimator is attached to said body part at an angle that makes the direction of said channels coincide with a desired propagation direction of X-rays within the X-ray spectrometric apparatus.
